(19) United States
(12) Patent Application Publication
(10) Pub. No.: US 2015/0037581 A1
(43) Pub. Date: Feb. 5, 2015

(54) CABLE HAVING STRENGTH MEMBER WITH BONDED POLYMER COATINGS TO CREATE CONTINUOUSLY BONDED JACKETED STRENGTH MEMBER SYSTEM

(71) Applicants: Joseph Varkey, Sugar Land, TX (US); Jushik Yun, Sugar Land, TX (US); Vadim Protasov, Houston, TX (US); Sheng Chang, Sugar Land, TX (US)

(72) Inventors: Joseph Varkey, Sugar Land, TX (US); Jushik Yun, Sugar Land, TX (US); Vadim Protasov, Houston, TX (US); Sheng Chang, Sugar Land, TX (US)

(73) Assignee: SCHLUMBERGER TECHNOLOGY CORPORATION, Sugar Land, TX (US)

(21) Appl. No.: 13/811,887

(22) PCT Filed: Jul. 22, 2011
(86) PCT No.: PCT/US11/44925

§ 371 Date: Aug. 5, 2014

Related U.S. Application Data
(60) Provisional application No. 61/400,182, filed on Jul. 23, 2010.

(51) Int. Cl. D07B 1/16; H01B 7/28; B65H 81/06; D07B 1/14

(52) U.S. Cl. CPC D07B 1/162; D07B 1/147; H01B 7/2806; B65H 81/06; D07B 2201/2012; D07B 2401/2025; D07B 2201/2088
USPC 428/380; 156/172

(57) ABSTRACT

The present disclosure comprises providing a cable core encased in a polymeric layer, cabling a first armor wire layer about the cable core, cabling a second armor wire layer about the first armor wire layer to form the cable, each of the armor wire layers comprising a plurality of strength members, at least one of the armor wire layers comprising a plurality of strength members having a polymeric layer bonded thereto.

### BACKGROUND

The invention is related in general to welisite equipment such as oilfield surface equipment, oilfield cables and the like.

Oil and gas exploration continues to expand into increasingly difficult environments. Wireline cables used in oilfield operations must be able to withstand increasingly high temperatures and pressures and must resist corrosive materials found in the depths of the well. Metallic strength members or “armor wires” cabled around the outside of the cable are particularly vulnerable to damage from corrosion or physical damage caused by the wires rubbing against one another. One solution has been to encase the strength members in polymeric jackets. Unfortunately, damage to the jacketing may allow corrosive materials to damage the metallic components inside. Additionally, gaps between the metallic components and the jacketing may create a pathway for high-pressure gases to travel along the cable, allowing more extensive damage to the cable and the possibility for high-pressure gases to escape at the well surface.

Currently, typical wireline cables use strength members consisting of bare wires made of galvanized improved plow steel. Other alloys may be used in situations that require additional strength or to mitigate corrosion in harsh downhole environments. In some cables, the strength members are also encased in polymeric jackets to provide some protection against downhole environments. In some instances, attempts are made to bond the polymer to the strength member.

It remains desirable to provide improvements in wireline cables and/or downhole assemblies.

### SUMMARY AND DETAILED DESCRIPTION

The embodiments disclosed herein comprise a continuously bonded jacket that encases strength member layers in wireline or other similar cables. Individual strength members are first coated with a polymer amended to bond to them. Bonding is accomplished by using a polymer amended to bond to the metal by novel extrusion process. A thin tie layer of amended polymer may be used over the metal followed by an extrusion of un-amended polymer or the entire jacket over the individual strength members may be amended polymer. Additionally, bonding may be facilitated by passing the metallic strength members pass through an infrared heat source to modify their surface properties prior to application of the amended polymer. As these individually jacketed strength members are applied helically over the cable, the polymer is softened, which allows the polymer to fill all interstitial spaces, bond to the rest of the polymeric material and be shaped into a continuously bonded, jacketed strength member system with a circular profile. As indicated in the Figures below, this system may be applied to any wireline cable such as mono cables, coaxial cables, hepta cables or any other suitable cable core configuration or seismic or any oceanographic, mining or any other cables.

### EMBODIMENT 1

### Continuously Bonded, Polymer Jacketed Strength Member Layers Assembled from Polymer-Bonded Strength Members

Embodiment 1 creates a continuously bonded jacket that encases strength member layers in wireline or other similar cables. Individual strength members used in this design are created using materials and techniques described in provisional application No. 61/343,577. As described in the provisional application and shown in FIG. 1, individual metallic components may be treated by infrared heat to modify their surfaces in FIG. 1.1. In FIG. 1.2, a “tie layer” of polymeric material amended to bond to the metal is extruded over the heat-treated metal. In FIG. 1.3, a final layer of non-amended polymer is extruded over and bonds to the tie layer. In an embodiment, the entire polymeric jacket may comprise the amended polymer that bonds to the metal.

Bonding is accomplished by using a polymer amended to bond to the metal. A thin tie layer of amended polymer may be used over the metal followed by an extrusion of un-amended polymer or the entire jacket over the individual strength members may be amended polymer. Additionally, bonding may be facilitated by passing the metallic strength members pass through an infrared heat source to modify their surface properties prior to application of the amended polymer. As these individually jacketed strength members are applied helically over the cable, the polymer is softened or surface melted, which allows the polymer to fill all interstitial spaces, bond to the rest of the polymeric material and be shaped into a continuously bonded, jacketed strength member system with a circular profile or similar suitable profile.

Referring now to FIGS. 2, 3, and 4, the method may be applied to monocables (FIG. 2), coaxial cables (FIG. 3), hepta cables (FIG. 4) or any other suitable cable core configuration. As shown in FIGS. 2.1, 3.1, and 4.1, the embodiment begins with a cable core (e.g., monocable, coaxial cable, or hepta cable or any other suitable core) encased in a polymeric jacket. As shown in FIGS. 2.2, 3.2, 4.2, an inner strength member layer, comprising a number of metallic strength members with bonded polymeric jackets are passed through an infrared heat source to soften or surface melted the polymer immediately before being cabled over the jacketed cable core. As shown in FIGS. 2.3, 3.3, 4.3, the softened polymeric jackets over the inner strength members deform to fill all interstitial spaces between strength members and the cable core. The polymer on the coated wire bonds to the polymer jacket of the core. The polymeric jackets bond together and the cable is drawn through a shaping die to create a circular profile or any suitable profile. As shown in FIGS. 2.4, 3.4, 4.4, the outer strength member layer, consisting of a number of metallic strength members with bonded polymeric jackets are passed through an infrared heat source to soften the polymer immediately before being cabled over the inner layer of jacketed strength members. As shown in FIGS. 2.5, 3.5, 4.5, the softened polymeric jackets over the outer strength members deform to fill all interstitial spaces between strength members and the jacket covering the inner strength members. The polymeric jackets bond together and the cable is drawn through a shaping die to create a circular profile or any suitable profile. If needed, additional polymer may be extruded over the outside of the cable to create a circular or similarly suitable profile outer jacket of the desired thickness.

In an embodiment, a continuously bonded jacket that encases strength member layers in wireline or other similar cables is disclosed. In the outer layer, individual strength members are first coated with a polymer amended to bond to them. The bonding is accomplished by using a polymer amended to bond to the metal. A thin tie layer of amended polymer may be used over the metal followed by an extrusion of un-amended polymer or the entire jacket over the individual strength members may be amended polymer. Additionally, bonding may be facilitated by passing the metallic strength members pass through an infrared heat source to modify their surface properties prior to application of the amended polymer. As these individually jacketed outer strength members are applied helically over the cable, the polymer is softened, which allows the polymer to fill all interstitial spaces, bond to the rest of the polymeric material and be shaped into a continuously bonded, jacketed strength member system. As indicated in FIGS. 5, 6, and 7, this system may be applied to monocables, coaxial cables, hepta cables or any other suitable cable core configuration. As shown in FIGS. 5.1, 6.1, 7.1, the embodiment begins with a cable core (e.g., monocable (FIG. 5), coaxial cable (FIG. 6), or hepta cable (FIG. 7) encased in a polymeric jacket. As shown in FIGS. 5.2, 6.2, and 7.2, the inner strength member layer consists of a number of metallic strength members that are cabled over and partially embedded into the jacketed cable core. As shown in FIGS. 5.3, 6.3, and 7.3, the softened polymeric jacket over the cable core deforms to fill all interstitial spaces between the strength members and the cable core. Optionally, as shown in FIG. 3a, an intermediate polymer jacket, comprising the same polymer as the used on the inner core, is extruded over the first armor layer. As shown in FIGS. 5.4, 6.4, and 7.4, the outer strength member layer, comprising a number of metallic strength members with bonded polymeric jackets are passed through an infrared heat source to soften the polymer immediately before being cabled over the inner layer of jacketed strength members. The jacketing on the outer strength members may be amended with short carbon fibers to strengthen the polymer. As shown in FIGS. 5.5, 6.5, and 7.5, the softened polymeric jackets over the outer strength members deform to fill all interstitial spaces between strength members and the jacket covering the inner strength members. The polymeric jackets bond together. As shown in FIGS. 5.6, 6.6, and 7.6 an optional final outer polymer jacket, comprising the same polymer as that used on the outer strength members is extruded over the outside of the cable to create a circular-profile outer jacket of the desired thickness.

The metallic wires used in the polymer-jacketed strength members described in this document may comprise but are not limited to; Copper-clad steel, Aluminum-clad steel, Anodized Aluminum-clad steel, Titanium-clad steel, Alloy 20Mo6HS, Alloy GD31Mo, Austenitic Stainless Steel, High Strength Galvanized Carbon Steel, Copper, Titanium clad copper and/or combinations thereof.

The polymer material may comprise a modified polyolefin that may be amended with materials where needed to facilitate bonding between materials that would not otherwise bond, the polymers may be amended with one of several adhesion promoters, such as but not limited to unsaturated anhydrides, (including maleic-anhydride, or 5-norbornene-2, 3-dicarboxylic anhydride), carboxylic acid, acrylic acid, or silanes. Trade names of commercially available, amended polyolefins with these adhesion promoters may comprise, but is not limited to, ADMER® from Mitsui Chemical, Fusabond®, Bynel® from DuPont, and Polybond® from Chemtura.

The polymer material may comprise modified TPX (4-methylpentene-1 based, crystalline polyolefin). Where needed to facilitate bonding between materials that would not otherwise bond, the described polymers may be amended with one of several adhesion promoters, such as but not limited to, unsaturated anhydrides, (mainly maleic-anhydride, or 5-norbornene-2, 3-dicarboxylic anhydride), carboxylic acid, acrylic acid, or silanes. TPX™ from Mitsui Chemical is a commercially available, amended TPX (4-methylpentene-1 based, crystalline polyolefin) with these adhesion promoters.

The polymer material may comprise a modified fluoropolymer comprising adhesion promoters may be used where needed to facilitate bonding between materials that would not otherwise bond. As listed above these adhesion promoters may comprise unsaturated anhydrides, (mainly maleic-anhydride or 5-norbornene-2, 3-dicarboxylic anhydride), carboxylic acid, acrylic acid, and silanes). Examples of commercially available fluoropolymers modified with adhesion promoters may comprise PFA (perfluoroalkoxy polymer) from DuPont Fluoropolymers, Modified PFA resin, Tefzel® from DuPont Fluoropolymers, Modified ETFE resin, which is designed to promote adhesion between polyamide and fluoropolymer. Neoflon™-modified Fluoropolymer from Daikin America, Inc., which is designed to promote adhesion between polyamide and fluoropolymer. FEP (Fluorinated ethylene propylene) from Daikin America, Inc or ETFE (Ethylene tetrafluoroethylene) from Daikin America, Inc., or EFEP (ethylene-fluorinated ethylene propylene) from Daikin America, Inc, and/or combinations thereof.

The polymer material may comprise polymer insulation unmodified and reinforced which have low dielectrical coefficient. The polymer material may comprise commercially available polyolefin that may be used unmodified or reinforced with carbon, glass, aramid or any other suitable natural or synthetic fiber. Along with fibers in polymer matrix, any other reinforcing additives may be utilized such as, but not limited to, micron sized PTFE, Graphite, Ceramer™:HDPE (High Density Polyethylene) LDPE (Low Density Polyethylene) PP (Ethylene tetrafluoroethylene) PP copolymer etc

Modified fluoropolymers comprising adhesion promoters may be used as the polymer material. Examples of commercially available fluoropolymers that may be used unmodified or reinforced with carbon, glass, aramid or any other suitable natural or synthetic fiber. Along with fibers in polymer matrix, any other reinforcing additives such as micron sized PTFE, Graphite, Ceramer™, ETFE (Ethylene tetrafluoroethylene) from Du Pont, ETFE (Ethylene tetrafluoroethylene) from Daikin America, Inc., EFEP (ethylene-fluorinated ethylene propylene) from Daikin America, Inc., PFA (perfluoroalkoxy polymer) from Dyneon™ Fluoropolymer, PFA (perfluoroalkoxy polymer) from Solvay Solexis, Inc., PFA (perfluoroalkoxy polymer) from Daikin America, Inc., PFA (perfluoroalkoxy polymer) from DuPont Fluoropolymer, Inc.and/or combinations thereof.

The jacketing materials may comprise polyamides such as, but not limited to, Nylon 6; Nylon 66; Nylon 6/66; Nylon 6/12; Nylon 6/10; Nylon 11; or Nylon 12. Trade names of commercially available versions of these polyamide materials include, but are not limited to, Orgalloy® RILSAN® or RILSAN® from Arkema; BASF Ultramid® Miramid® from BASF; Zytel® DuPont Engineering Polymers.

The jacketing materials may comprise unmodified and reinforced Fluoropolymers. Examples of commercially available fluoropolymers that may be used as is or reinforced with carbon, glass, aramid or any other suitable natural or synthetic fiber. Along with fibers in polymer matrix, any other reinforcing additives such as micron sized PTFE, Graphite, Ceramer™, ETFE (Ethylene tetrafluoroethylene) from Du Pont, ETFE (Ethylene tetrafluoroethylene) from Daikin America, Inc., EFEP (ethylene-fluorinated ethylene propylene) from Daikin America, Inc., PFA (perfluoroalkoxy polymer) from Dyneon™ Fluoropolymer, PFA (perfluoroalkoxy polymer) from Solvay Slexis, Inc., PFA (perfluoroalkoxy polymer) from Daikin America, Inc., PFA (perfluoroalkoxy polymer) from DuPont Fluoropolymer, Inc. and/or combinations thereof.

The embodiments described herein create continuously bonded polymeric-jacketed strength member systems using individually jacketed, bonded strength members. These strength members are heated during cabling to allow their polymeric jackets to flow and bond into a continuous jacket that bonds to a polymeric jacket over the cable core; all of the individual strength members; and any subsequent, strength member layers of the same configuration.

All materials from the cable core to the outer jacket are bonded to one another; all metallic components are separated by polymeric insulation. This insulation protects the metallic components against infiltration of and damage by downhole materials. The insulation also allows protects metallic components from physical damage by rubbing against one another during oilfield operations (for example, when being drawn over sheaves under tension or the like).

The preceding description has been presented with reference to present embodiments. Persons skilled in the art and technology to which this disclosure pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

We claim:

1. A cable as shown and described.

2. A method for using a cable as shown and described.

3. A method for manufacturing a cable, comprising:
providing a cable core encased in a polymeric layer;
cabling a first armor wire layer about the cable core;
cabling a second armor wire layer about the first armor wire layer to form the cable, each of the armor wire layers comprising a plurality of strength members, at least one of the armor wire layers comprising a plurality of strength members having a polymeric layer bonded thereto.

4. The method of claim 3 wherein the at least one strength member comprises at least one of copper-clad steel, aluminum-clad steel, anodized aluminum-clad steel, titanium-clad steel, carpenter alloy 20mo6hs, gd31 mo, austenitic stainless steel, high strength galvanized carbon steel, copper, titanium clad copper, and combinations thereof.

5. The method of claim 3 wherein providing a polymeric layer comprises providing at least one of a modified polyolefin, a modified TPX, and a modified polyolefin.

6. The method of claim 3 further comprising extruding at least one jacket layer over the cable.

7. The method of claim 6 further comprising heating the polymeric layer prior to extruding the jacket layer.

8. The method of claim 3 further comprising extruding at least one polymeric layer over a one of the armor wire layers.

9. The method of claim 3 wherein the cable comprises a continuously bonded cable.

10. The method of claim 3 wherein the cable comprises a wireline cable.

11. The method of claim 3 wherein the cable comprises a seismic cable.

12. The method of claim 3 wherein the cable comprises a slickline cable.
